(19) United States
(12) Patent Application Publication
(10) Pub. No.: US 2009/0158665 A1
(43) Pub. Date: Jun. 25, 2009

(54) Door grating extension/contraction structure

(76) Inventor: Sung-Tsun Wu, Pan Chiao City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/222,079

(22) Filed: Aug. 1, 2008

(30) Foreign Application Priority Data
Dec. 19, 2007 (TW) 096221577

(51) Int. Cl. E06B 9/02

(52) U.S. Cl. 49/55

(57) ABSTRACT

A door grating extension/contraction structure includes a frame and an extension/contraction mechanism. The frame is comprised of a plurality of bars. The extension/contraction mechanism is mounted to two parallel bars of the frame and is comprised of a telescopic tube set and a release assembly, wherein the telescopic tube set comprises a movable rod and the release assembly is coupled to the telescopic tube set and comprises a release button, a pawl member, and a transmission unit. The release button is coupled with the transmission unit and the transmission unit is coupled with the pawl member to form a resilient interconnection. The pawl member corresponds to and selectively forms an adjustable engagement with the movable rod of the telescopic tube set. The release button is operative to control engagement and disengagement between the pawl member and the movable rod, whereby the extension/contraction mechanism that is coupled to the frame can realize one-way or two-way extension/contraction to provide the door grating extension/contraction structure.

### FIELD OF THE INVENTION

The present invention relates to a door grating extension/contraction structure, and in particular to a door grating comprised of a frame formed by interconnecting a plurality of bars, of which at least two parallel ones are provided with an extension/contraction mechanism, which comprises a combination of a telescopic tube set and a release assembly to realize extension/contraction of the telescopic tube set for flexibly adjusting an overall length of the frame for setting in door frames of different sizes, various stairways, or between walls and thus applicable to a door barrier grating structure or the likes.

### BACKGROUND OF THE INVENTION

Indoor decoration of family housing only puts the needs of adults into consideration and such indoor decoration remains unchanged even after the birth of new born babies. Thus, family house often becomes a dangerous environment for young children. Most injuries of the young children occur in the houses, including fall, tumble, and burning in for example kitchens. Apparently, for young children or babies, who are of poor action controllability, have no recognition of dangerous conditions, have an increased ratio of head with respect to the whole body, and poor balance, family house is a place full of dangers.

To facilitate protection of young children or babies from the dangers, door grating is often arranged in the passage to for example kitchens, bathrooms, stairways, where dangers often occur, so as to isolate the young children or babies from the dangerous locations. Such grating also serves to confine family pets in certain locations. Conventionally, a door grating is often comprised of steel bars that are welded to make a frame, of which the manufacturing costs are high and the size is fixed, lacking flexibility in applications. To improve such problems, combinative gratings are available, which are formed by first making separate corner members and bars and then combining the corner members and the bars together to form a frame of the door grating. Such combinative gratings are of a modularized design that allows for mass production, leading to lower costs. However, the assembling and disassembling of the conventional combinative gratings are time- and labor-consuming. Further, flexible adjustment of the frame size of the grating is still impossible.

In view of such problems, the present invention is aimed to provide a solution to such problems.

### SUMMARY OF THE INVENTION

A primary objective of the present invention is to provide a door grating extension/contraction structure comprising a plurality of bars interconnected to make a frame and an extension/contraction mechanism provided on at least two parallel ones of the bars. The extension/contraction mechanism is comprised of a combination of a telescopic tube set and a release assembly and is operated by depression and/or release of a release button of the release assembly to control the telescopic tube set so as to extend/contract the telescopic tube set for flexibly adjusting the frame for setting in door frames of different sizes, various stairways, or between walls to thereby facilitate the overall practicability and convenience.

Another objective of the present invention is to provide a door grating extension/contraction structure comprising an extension/contraction mechanism having a release assembly that is comprised of a release button, a transmission unit, and a pawl member, wherein the transmission unit provides a resilient interconnection between the components so that the location for arranging the release assembly is flexible to thereby enhance the convenience of the operation and use of the extendable frame and thus improving the overall practicability and convenience.

A further objective of the present invention is to provide a door grating extension/contraction structure comprising an extension/contraction mechanism having a telescopic tube set that is comprised of a movable rod that is set corresponding to and engageable with a pawl member of a release assembly and is configured with a slope so that one-way extension of a frame of the door grating can be realized without actuating a release button of the release assembly, making the use and operation of the extension/contraction mechanism more convenient and thus enhancing overall practicability and convenience.

Yet a further objective of the present invention is to provide a door frame extension/contraction structure comprising a combined assembly of a frame formed by interconnecting a plurality of bars and an extension/contraction mechanism provided on at least two parallel ones of the bars, with a corner section provided between adjacent bars for interconnection and further comprising a folding section arranged at joints between the bars to realize folding of a frame of the door grating for easy storage thereby enhancing overall practicability and convenience.

To realize the above objectives, in accordance with the present invention, a door grating extension/contraction structure comprises a frame and an extension/contraction mechanism. The frame is comprised of a plurality of bars. An extension/contraction mechanism is mounted to two parallel ones of the bars and is comprised of a telescopic tube set and a release assembly, wherein the telescopic tube set comprises a movable rod and the release assembly is coupled to the telescopic tube set and comprises a release button, a pawl member, and a transmission unit. The release button is coupled with the transmission unit and the transmission unit is coupled with the pawl member to form a resilient interconnection. The pawl member corresponds to and selectively forms an adjustable engagement with the movable rod of the telescopic tube set. The release button is operative to control engagement and disengagement between the pawl member and the movable rod, whereby the extension/contraction mechanism that is coupled to the frame can realize one-way or two-way extension/contraction to provide the door grating extension/contraction structure.

### BRIEF DESCRIPTION OF THE DRAWINGS

The present invention will be apparent to those skilled in the art by reading the following description of preferred embodiments thereof with reference to the drawings, in which:

FIG. 1 is a perspective view of a first embodiment of the present invention;

FIG. 2 is an exploded view of a portion of an extension/contraction mechanism of the first embodiment of the present invention;

FIG. 3 is a cross-sectional view illustrating an engagement condition of a release assembly of the first embodiment of the present invention;

FIG. 4 is a cross-sectional view illustrating a disengagement condition of the release assembly of the first embodiment of the present invention;

FIG. 5 is an exploded view of a portion of an extension/contraction mechanism of a second embodiment of the present invention;

FIG. 6 is a schematic view illustrating a corner section and a stop in accordance with the second embodiment of the present invention; and

FIG. 7 is a perspective view illustrating an application of the second embodiment of the present invention.

### DETAILED DESCRIPTION OF THE PREFERRED EMBODIMENTS

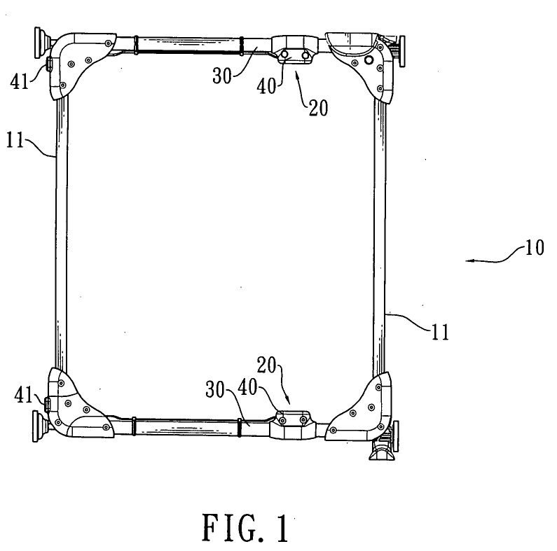

With reference to the drawings and in particular to FIG. 1, a door grating extension/contraction structure in accordance with the present invention comprises a frame 10 and an extension/contraction mechanism 20. The frame 10 consists of a plurality of bars 11 and is formed by interconnecting a plurality of bars 11. The two extension/contraction mechanisms 20 are respectively arranged on two parallel ones of the bars 11 of the frame 10 and each extension/contraction mechanism 20 is comprised of a telescopic tube set 30 and a release assembly 40.

Referring to FIGS. 24, the telescopic tube set 30 of the extension/contraction mechanism 20 comprises a movable rod 31 and in the embodiment illustrated, the telescopic tube set 30 consists of an outer tube 33 and an inner tube 32, wherein the inner tube 32 is fit in the outer tube 33 and is movable within the outer tube 33. The movable rod 31 is received and coupled inside the inner tube 32 and the movable rod 31 forms a plurality of engagement notches 311 for effecting adjustable engagement. The outer tube 33 and the inner tube 32 are respectively provided with openings 331, 321 for the extension of a pawl member 43 of the release assembly 40, which will be described hereinafter. The telescopic tube set 30 is further provided with a stop 312 for preventing the outer tube 33 and the inner tube 32 of the telescopic tube set 30 from excessive movement beyond a preset range of movement and thus causing the frame 10 to be detached.

The release assembly 40 is mounted to the telescopic tube set 30 and comprises a release button 41, a pawl member 43, and a transmission unit 42. The release button 41 is operatively and movably coupled to the transmission unit 42 and the transmission unit 42 is coupled to the pawl member 43 to establish a resilient interconnection therebetween. The transmission unit 42 of the release assembly 40 comprises an abutting member 421, a driving member 422, a control cable 423, and at least one spring 424. The abutting member 421 corresponds to and operatively abuts against the driving member 422. The control cable 423 has an end 423a that is arranged between the abutting member 421 and the driving member 422 and is movably coupled with the abutting member 421 and the driving member 422. The spring 424 is arranged at an end of the release button 41 that opposes the abutting member 421 and is coupled to the release button 41 of the release assembly 40 to allow the release button 41 of the release assembly 40 to be depressible to push against and drive the abutting member 421, which in turn causes rotation of the driving member 422 for operating the control cable 423 thereby realizing operative interconnection. The control cable 423 of the transmission unit 42 has another end 423b that is coupled to the pawl member 43 of the release assembly 40 and is further provided with at least one resilient element 425, which in the embodiment illustrated comprises a spring, for effecting resilient position returning thereby facilitating operative interconnection of the control cable 423 of the transmission unit 42 with respect to the pawl member 43 of the release assembly 40. The pawl member 43 of the release assembly 40 corresponds to and forms an adjustable engagement with the engagement notches 311 of the movable rod 31 of the telescopic tube set 30, whereby the release button 41 of the release assembly 40 is operable to control engagement/disengagement between the pawl member 43 and the movable rod 31.

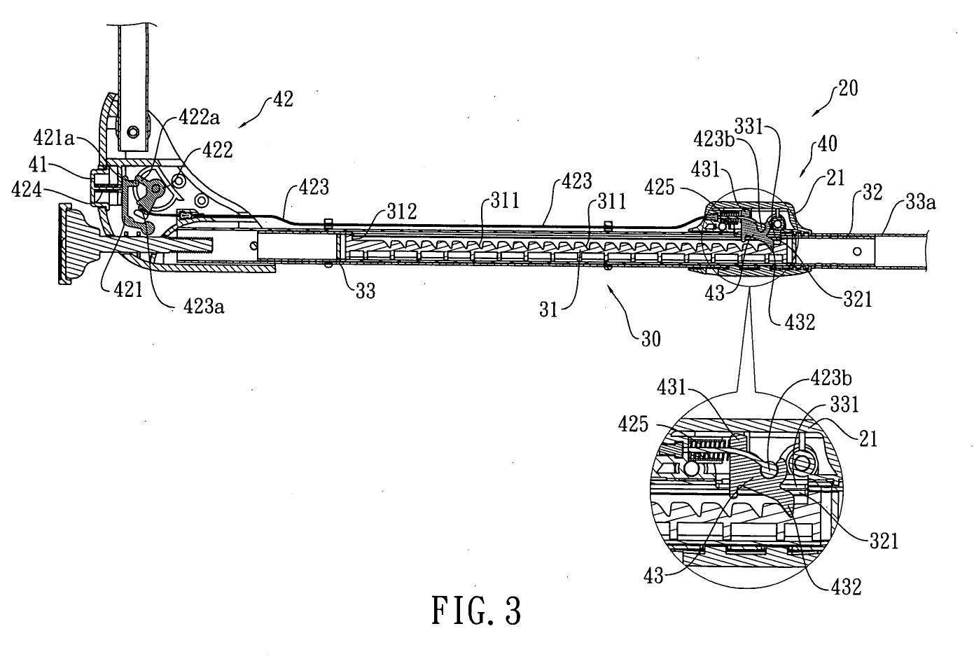

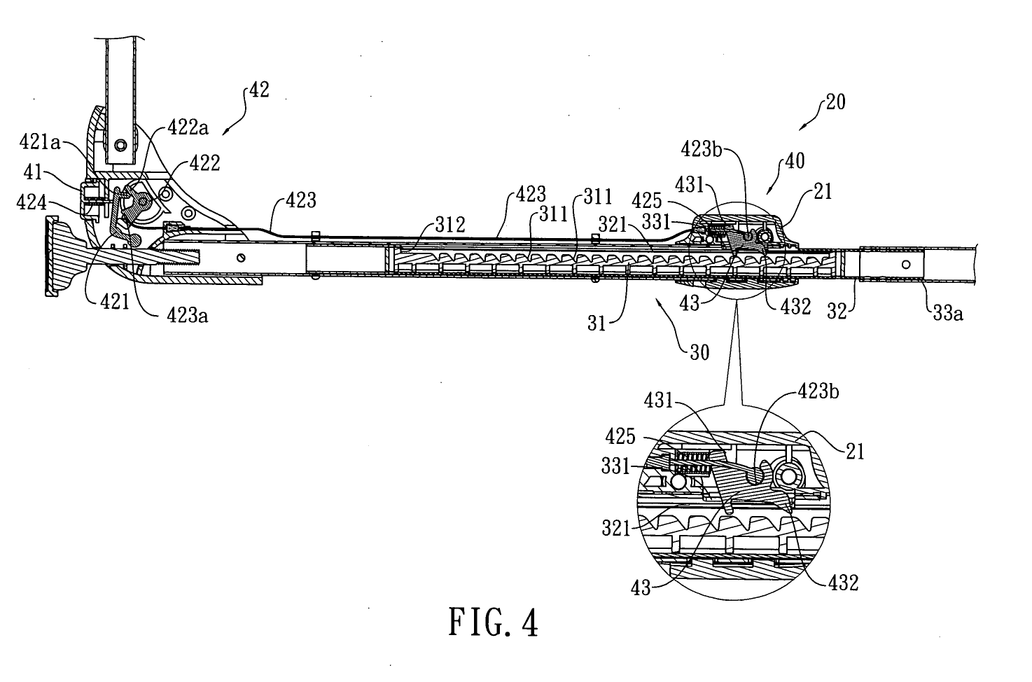

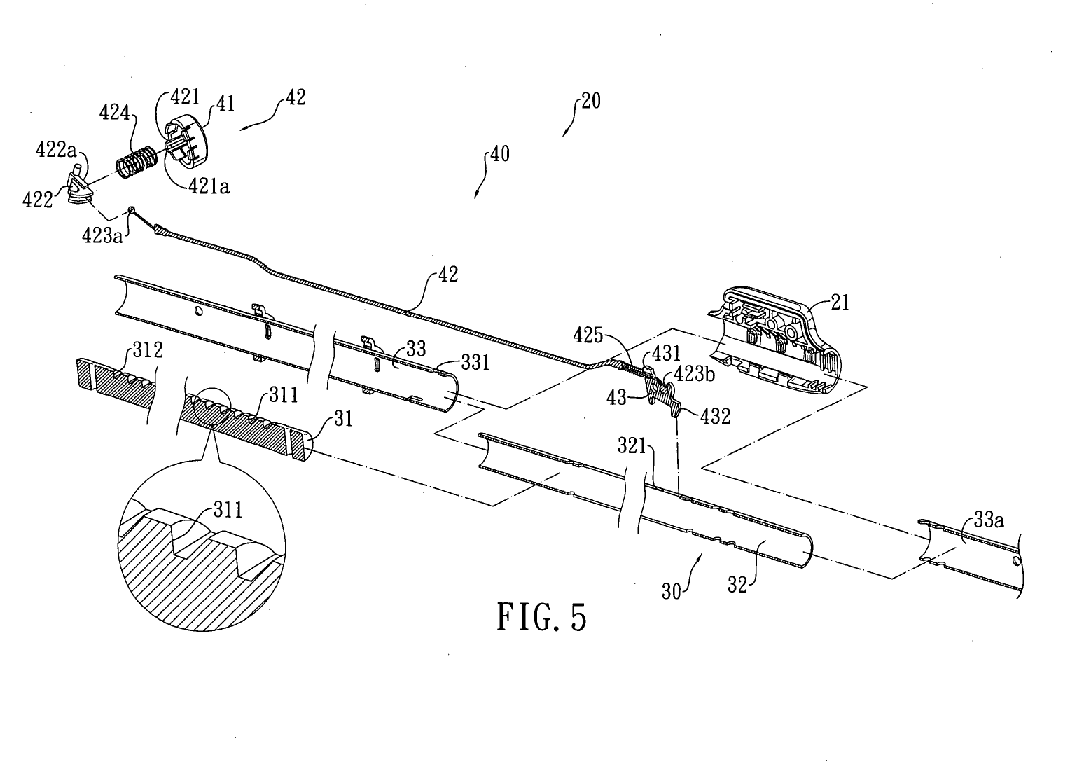

Referring to FIGS. 3 and 4, to use the extension/contraction mechanism 20 in accordance with the present invention, the engagement condition (FIG. 3) and/or disengagement condition (FIG. 4) between the pawl member 43 of the release assembly 40 and the engagement notches 311 of the movable rod 31 of the telescopic tube set 30 is selectively effected to realize movement of the telescopic tube set 30. The outer tube 33 is divided into two sections at a location where the pawl member 43 of the release assembly 40 is received therein, and one section 33a of the outer tube 33 is fixed to the inner tube 32, whereby when the telescopic tube set 30 extends/contracts, the outer tube section 33a is movable in unison with the inner tube 32 that it coupled with the movable rod 31 therein. When the release button 41 of the release assembly 40 is depressed, the spring 424 coupled to the release button 41 is compressed to abut against an inside wall that is adjacent to the abutting member 421, and at the same time, the release button 41 abuts against the abutting member 421 of the transmission unit 42 to cause movement of the abutting member 421. Then, an end 421a of the abutting member 421 drives the an end 422a of the driving member 422 of the transmission unit 42, causing rotation of the driving member 422, which, while rotating, drives the control cable 423 of which the end 423a is coupled to the driving member 422, so that another end 423b of the control cable 423 is caused to drive the pawl member 43 of the release assembly 40, making an end 432 of the pawl member 43 withdrawn out of or disengaged from the engagement notches 311 of the movable rod 31 of the telescopic tube set 30 to realize the disengagement condition. Meanwhile, a side wall 431 of the pawl member 43 compresses the resilient element (spring) 425 that is fit over and coupled to said another end 423b of the control cable 423. Under the disengagement condition, the inner tube 32 of the telescopic tube set 30, which is coupled with the movable rod 31, is allowed to extend out of or retract back into the outer tube 33. When the release button 41 is released, with the resilient restoration effected by the spring 424 and the resilient element 425 and further due to the pushing of the resilient element 425, the end 432 of the pawl member 43 of the release assembly 40 is caused to return and re-fit into the engagement notches 311 of the movable rod 31 of the telescopic tube set 30 to form the engagement condition. Under the engagement condition, since the end 432 of the pawl member 43 of the release assembly 40 can be of a design of double-sloped body (as shown in FIG. 5), which is insertable into and engageable with the corresponding engagement notch 311 of the movable rod 31 of the telescopic tube set 30 to effect positioning of the inner tube 32 and the outer tube 33 of the telescopic tube set 30, preventing them from movement and extension/contraction with respect to each other.

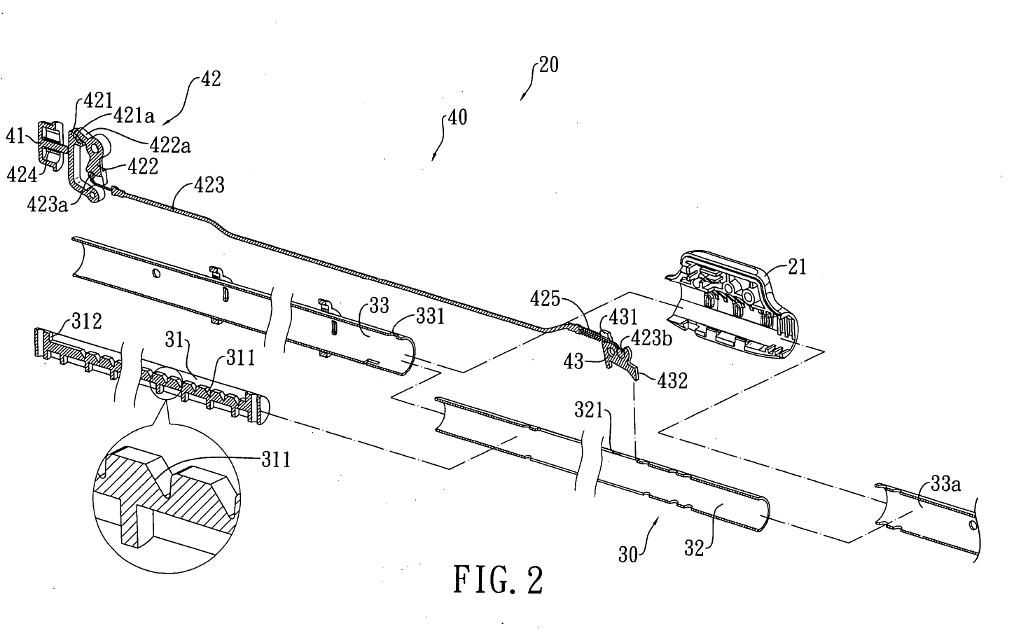

Further, under the engagement condition, the end 432 of the pawl member 43 of the release assembly 40 can be made a single-sloped body (as shown in FIGS. 2-4), while each engagement notch 311 of the movable rod 31 of the telescopic tube set 30 is formed as a single-slope groove corresponding to the single-sloped body of the end 432 of the pawl member 43. Since the pawl member 43 is allowed to slide off the engagement notch 311 of the movable rod 31 in the direction of the slope, forming a movable engagement in a direction corresponding to the slope, the inner tube 32 of the telescopic tube set 30 that is coupled with the movable rod 31 and the outer tube section 33a that is fixed to the inner tube 32 are allowed to move in a direction opposite to the slope thereby realizing a one-way moveability of the frame 10. Under the disengagement condition, the inner tube 32 and the outer tube 33 of the telescopic tube set 30 are allowed to move with respect to each other in opposite directions, of which the operation is identical to what described above and is thus omitted for simplification.

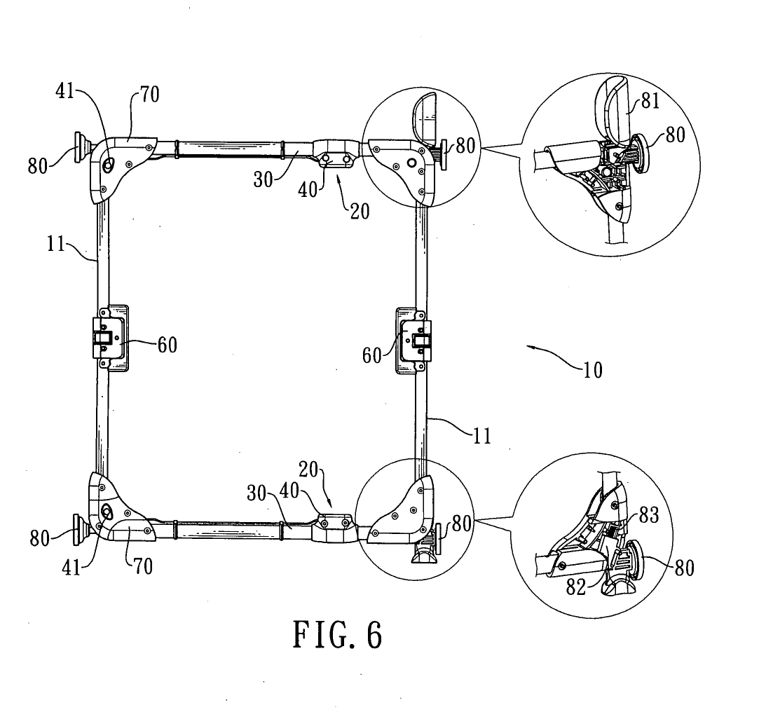

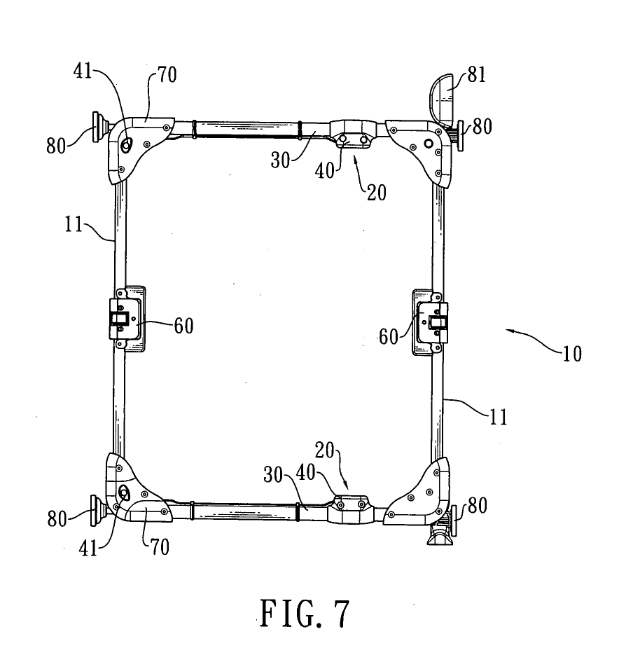

Referring to FIGS. 6 and 7, the release button 41 of the release assembly 40 can be set at a different location. For example, when the release button 41 is set on a front side of the frame 10 (as shown in FIG. 7), the release button 41 of the release assembly 40 and the abutting member 421 of the transmission unit 42 can be combined as a unitary member (as shown in FIG. 5) and the operative relationship is the same as what was described previously and the description thereof is omitted. In this way, the operation and use of the extension/contraction mechanism 20 can be further enhanced.

Further, the extension/contraction mechanism 20 can further comprise a casing 21 (see FIGS. 2 and 5) that encloses the telescopic tube set 30 and the release assembly 40 of the extension/contraction mechanism 20. The casing 21 can be of a configuration that partially or completely encloses the telescopic tube set 30 and/or release assembly 40. In the embodiment illustrated, the casing 21 partially encloses the telescopic tube set 30 and the casing 21 defines therein a passage for the extension of the inner tube 32 and the outer tube 33 of the telescopic tube set 30 in such a way that the casing 21 encloses where the inner tube 32 and the outer tube 33 inter-fit each other, and also, the pawl member 43 of the release assembly 40, the resilient element 425, and the end 423b of the control cable 423 that is coupled to the pawl member 43 are enclosed inside the casing 21.

Reference is now made to FIGS. 1-7, with the structure described above, the door grating extension/contraction structure of the present invention features that a frame 10 is comprised of a plurality of bars 11 of which at least two parallel ones are provided with an extension/contraction mechanism 20, which is comprised of a combination of the telescopic tube set 30 and the release assembly 40 that comprises the release button 41, the transmission unit 42, and the pawl member 43, whereby by means of depression/release of the release button 41, the telescopic tube set 30 is controlled to effect extension/contraction or movement of the telescopic tube set 30 for realizing adjustment of the frame 10 for being fit in door frames of different sizes, various stairways passages or between walls. Further, the present invention features the transmission unit 42 arranged between the release button 41 and the pawl member 43 to form a resilient interconnection among the components whereby by means of depression/release of the release button 41, the pawl member 43 is driven to switch between engagement and disengagement positions thereby realizing extension/contraction of the telescopic tube set 30. In addition, the transmission unit 42 provides flexibility of arranging the position of the release button 41 so as to facilitate the operation and use thereof. Further, with an end 432 of the pawl member 43 formed as a single-sloped body and each engagement notch 311 of the movable rod 31 formed as a single-slope groove, engagement in the direction of the slope is effected, thereby realizing one-way moveability of the frame 10. Further, the end 432 of the pawl member 43 can also be made in a double-sloped configuration, which, with proper depression/release of the release button 41, realizes two-way moveability of the frame 10. Thus, in accordance with the above description, a door grating extension/contraction structure featuring one-way or two-way extension/contraction is provided, which facilitates the overall practicability and convenience.

Referring to FIGS. 6 and 7, in an application of the present invention, adjacent bars 11 of the frame 10 can be further provided with a corner section 70 for interconnection between the bars 11. The frame 10 comprises two stops 80 that are arranged at two ends of the bar 11 of one side of the frame 10, and also comprises upper and lower stops 80 on the bar 11 on the other side of the frame 10. The upper stop 80 of the frame 10 comprises a handle 81 for forcing the stop 80 outward and against a wall. The lower stop 80 of the frame 10 comprises a slide 82 that is coupled with a spring 83 for driving the stop 80 to slide to abut against a wall. By means of the corner sections 70 and the bars 11 and the stops 80, a door grating is formed. The frame 10 can be further provided with a folding section 60, which works with the operation of the corner sections 70, allows the bar 11 to be folded for reducing the overall volume of the door grating thereby facilitating folding of the frame 10 of the door grating to provide convenience of storage, which leads to enhanced overall practicability and convenience.

Although the present invention has been described with reference to the preferred embodiment thereof, it is apparent to those skilled in the art that a variety of modifications and changes may be made without departing from the scope of the present invention which is intended to be defined by the appended claims.

What is claimed is:

1. A door grating extension/contraction structure, comprising:
a frame comprised of a plurality of bars; and
an extension/contraction mechanism, which is mounted to two parallel bars of the frame and is comprised of a telescopic tube set and a release assembly, wherein the telescopic tube set comprises a movable rod and the release assembly is coupled to the telescopic tube set and comprises a release button, a pawl member, and a transmission unit, in which the release button is coupled with the transmission unit and the transmission unit is coupled with the pawl member to form a resilient interconnection, the pawl member being corresponding to and selectively forming an adjustable engagement with the movable rod of the telescopic tube set, the release button being operative to control engagement and disengagement between the pawl member and the movable rod,
whereby the extension/contraction mechanism that is coupled to the frame can realize one-way or two-way extension/contraction to provide the door grating extension/contraction structure.

2. The door grating extension/contraction structure as claimed in claim 1, wherein the transmission unit of the release assembly comprises an abutting member, a driving member, a control cable, and at least one spring, the abutting member corresponding to and abutting against the driving member, the control cable having an end movably coupled to the abutting member and the driving member, the spring being set to correspond to the abutting member and couple to the release button of the release assembly to realize operative interconnection.

3. The door grating extension/contraction structure as claimed in claim 2, wherein the control cable of the transmission unit has another end that is provided with at least one resilient element therebetween with the pawl member of the release assembly to facilitate an operative interconnection thereof with the pawl member of the release assembly.

4. The door grating extension/contraction structure as claimed in claim 1, wherein the pawl member of the release assembly has an end forming a double-sloped configuration and wherein the movable rod of the telescopic tube set forms a plurality of engagement notches for effecting adjustable engagement.

5. The door grating extension/contraction structure as claimed in claim 1, wherein the pawl member of the release assembly has an end forming a single-sloped configuration and wherein the movable rod of the telescopic tube set forms a plurality of engagement notches, which have the form of single-sloped grooves, for effecting adjustable engagement in a direction corresponding to the slope.

6. The door grating extension/contraction structure as claimed in claim 1 further comprising a casing that encloses the telescopic tube set and the release assembly of the extension/contraction mechanism.

7. The door grating extension/contraction structure as claimed in claim 1, wherein the telescopic tube set of the extension/contraction mechanism further comprises a stop for preventing the telescopic tube set from excessive movement beyond a preset range of movement and thus causing the bars to be detached.

8. The door grating extension/contraction structure as claimed in claim 1, wherein a corner section is provided between adjacent bars to interconnect the bars.

9. The door grating extension/contraction structure as claimed in claim 1, wherein the frame comprises two first stops arranged at two ends of the bar of one side of the frame and upper and lower stops arranged on the bar on an opposite side of the frame, the upper stop of the frame comprising a handle for forcing the upper stop outward and against a wall, the lower stop of the frame comprising a slide that is coupled with a spring for driving the lower stop to slide to abut against a wall.
